(19) United States
(12) Patent Application Publication
(10) Pub. No.: US 2010/0053101 A1
(43) Pub. Date: Mar. 4, 2010

(54) OPTICAL FILM, LAMINATE AND TOUCH PANEL

(76) Inventors: Kazuhiro Nozawa, Saitama (JP); Masato Saito, Saitama (JP)

Correspondence Address: BACON & THOMAS, PLLC, 625 SLATERS LANE, FOURTH FLOOR, ALEXANDRIA, VA, 22314-1176, US

(21) Appl. No.: 12/531,992

(22) PCT Filed: Feb. 24, 2009
(86) PCT No.: PCT/JP2009/053272

§ 371 Date: Sep. 18, 2009

(30) Foreign Application Priority Data
Mar. 21, 2008 (JP) 2008-074230

(51) Int. Cl. G06F 3/041; B32B 7/02

(52) U.S. Cl. 345/173; 428/212

(57) ABSTRACT

An optical film that can make interference fringes inconspicuous with maintaining high surface hardness and transmission sharpness is provided.

The optical film 1 has a transparent base material layer 12. An undercoat layer 14 is laminated on at least one surface of the transparent base material layer 12. A transparent hard coat layer 16 is laminated on the undercoat layer 14. An anti-reflection layer 18 is laminated on the transparent hard coat layer 16. The anti-reflection layer 18 is a layer having a low refractive index smaller than the refractive index of the transparent hard coat layer 16. The layers are designed so that refractive index n0 of the transparent base material layer 12, refractive index n1 of the undercoat layer 14, refractive index n2 of the transparent hard coat layer 16, and refractive index n3 of the anti-reflection layer 18 should satisfy the relationships of n3<n2≦n1≦n0, and (n0−n3)≦0.5.

### TECHNICAL FIELD

The present invention relates to an optical film, a laminate, and a touch panel.

### BACKGROUND ART

An optical film comprising a transparent base material film and a transparent resin film showing high surface hardness and scratch resistance (henceforth referred to as “transparent hard coat film”) and formed on a surface of the transparent base material film is known (Patent document 1).

Patent document 1: Japanese Patent Unexamined Publication (KOKAI) No. 2003-334891

### DISCLOSURE OF THE INVENTION

### Object to be Achieved by the Invention

However, in the optical film described in Patent document 1, interference fringes tend to become conspicuous. Theoretically, such interference fringes may be eliminated by completely eliminating unevenness in thickness of the transparent hard coat film. However, it is difficult to completely eliminate unevenness in thickness of the transparent hard coat film with currently realizable precision of film formation.

As a means for eliminating interference fringes resulting from unevenness of thickness, it is conceivable to design such an optical film so that the transparent base material film and the transparent hard coat film should have the same refractive index. However, such control of the refractive index unavoidably results in decrease of the surface hardness of the transparent hard coat film.

As another means for eliminating interference fringes resulting from unevenness of thickness, it is also conceivable to add a large amount of matting agent to the transparent hard coat film to impart unevenness to the surface of the transparent hard coat film. However, if unevenness is imparted to the surface of the transparent hard coat film, resolution of images observed through the optical film (transmission sharpness) is degraded.

An object of the present invention is to provide an optical film in which interference fringes are inconspicuous, while high surface hardness and transmission sharpness are maintained. Another object of the present invention is to provide a laminate comprising such an optical film, and a touch panel comprising such a laminate.

### Means for Achieving the Object

According to the present invention, the aforementioned object is achieved by designing such an optical film so that the refractive indexes of the transparent base material layer, undercoat layer, transparent hard coat layer and anti-reflection layer should become smaller in this order, and difference between refractive indexes of the transparent base material layer and the anti-reflection layer should be smaller than a predetermined value.

### EFFECT OF THE INVENTION

According to the present invention, the optical film is designed so that the refractive indexes of the layers constituting the optical film should be in predetermined relationships, and therefore interference fringes are inconspicuous in the optical film, while high surface hardness and transmission sharpness are maintained. Moreover, the refractive indexes of the layers are chosen so that they should be in predetermined relationships, even if a thin anti-reflection layer is formed on the outermost surface thereof, generation of interference fringes resulting from unevenness of thickness can be suppressed.

### BRIEF DESCRIPTION OF THE DRAWINGS

FIG. 1 is a sectional view of an example of the optical film of the present invention.

FIG. 2 is a sectional view of a laminate comprising the optical film of FIG. 1.

FIG. 3 is a sectional view of a touch panel comprising the laminate of FIG. 2.

### EXPLANATION OF NUMERICAL NOTATIONS

1 . . . Optical film, 12 . . . base material layer, 14 undercoat layer, 16 . . . resin layer, 18 . . . anti-reflection layer, 3 . . . laminate, 32 . . . transparent substrate, 34 . . . transparent conductive film, 5 . . . touch panel, 52 . . . upper electrode substrate (first electrode substrate), 522 . . . upper transparent substrate (first transparent substrate), 524 . . . upper transparent conductive film (first transparent conductive film), 54 . . . lower electrode substrate (second electrode substrate), 542 . . . lower transparent substrate (second transparent substrate), 544 . . . lower transparent conductive film (second transparent conductive film), 56, 58 . . . spacer, 7 adhesive layer, 9 . . . display device.

### BEST MODE FOR CARRYING OUT THE INVENTION

Hereafter, embodiments of the present invention will be explained with reference to the drawings.

In this embodiments, the interference fringes resulting from unevenness of thickness, and unevenness of color caused by the interference fringes are collectively referred to as “interference unevenness”.

### <<Optical Film>>

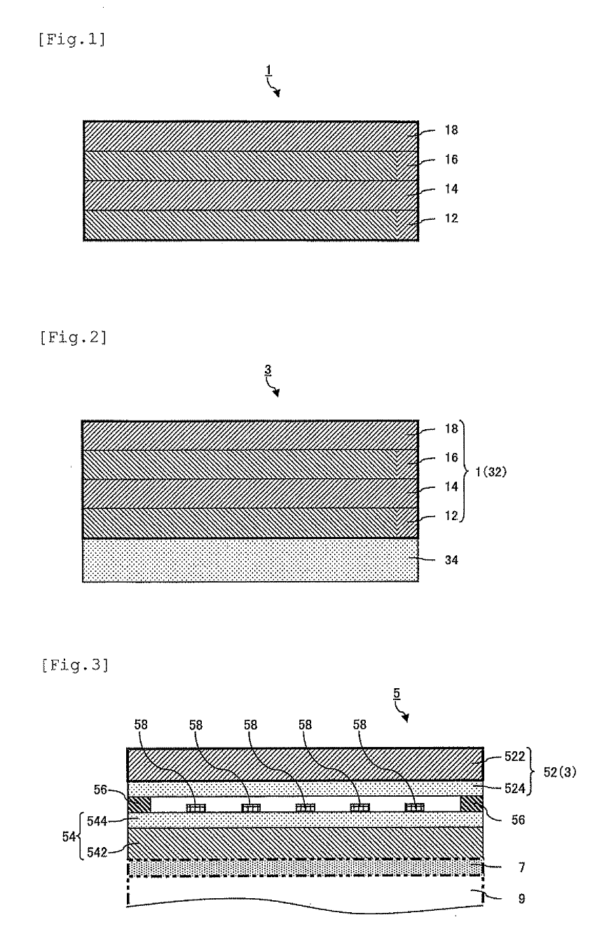

The optical film 1 shown in FIG. 1 has a transparent base material layer 12. An undercoat layer 14 is laminated on at least one surface of the transparent base material layer 12. A transparent hard coat layer 16 is laminated on the undercoat layer 14. An anti-reflection layer 18 is laminated on the transparent hard coat layer 16. The anti-reflection layer 18 is a layer having a low refractive index smaller than the refractive index of the transparent hard coat layer 16.

### <<Transparent Base Material Layer>>

Material of the transparent base material layer 12 is not particularly limited, and it is constituted with a resin base material usually used as a base material of optical film 1. A resin base material showing flexibility is especially preferred. Type of the resin constituting the resin base material is not particularly limited. Examples of the resin in the case of forming the resin base material in the shape of film or sheet include, for example, polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, fluorocarbon resins, cyclic polyolefins, and so forth. It is especially preferable to constitute the transparent base material layer 12 with biaxially stretched polyethylene terephthalate, since it shows superior mechanical strength and dimensional stability. When use for a purpose requiring heat resistance is contemplated, it is preferable to constitute the transparent base material layer 12 with polyethylene naphthalate, which shows superior heat resistance. Although these resin base materials may be transparent or translucent, a transparent resin base material is preferred. The term “transparent” used herein means a total light transmission of 50% or more, preferably 70% or more. Moreover, the resin base material may be colored or colorless, and it may be suitably determined according to the use.

Thickness of the transparent base material layer 12 is not particularly limited so long as any problem is not caused concerning handling thereof, and it is, for example, about 10 to 500 μm, preferably 12 to 350 μm.

### <<Undercoat Layer>>

The undercoat layer 14 is formed in order to improve adhesion between the transparent hard coat layer 16 and the transparent base material layer 12 without degrading the hard coat property of the transparent hard coat layer 16. It is sufficient that the undercoat layer 14 is formed on at least one surface of the transparent base material layer 12, but it may be formed on both surfaces of the transparent base material layer 21.

The undercoat layer 14 is formed from, for example, a thermoplastic resin or a thermosetting resin. Examples of the thermoplastic resin and the thermosetting resin include, for example, polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins, silicone resins, and so forth.

Thickness of the undercoat layer 14 is preferably about 0.03 to 1 μm. With a thickness of the undercoat layer 14 larger than the predetermined thickness, adhesion with the transparent base material layer 12 or the transparent hard coat layer 16 can be improved. With a thickness of the undercoat layer 14 smaller than the predetermined thickness, degradation of the hard coat property of the transparent hard coat layer 16 can be prevented, and coloration of the whole optical film 1 is also prevented when the transparent hard coat layer 16 and the anti-reflection layer 18 are laminated.

The undercoat layer 14 of this embodiments is preferably adjusted to have a value of wet tension of 40 mN/m or higher as determined according to JIS-K6768 (1999). With a value of wet tension higher than the predetermined value, the transparent hard coat layer 16 is formed as a uniform and smooth coated film showing no unevenness. Interference unevenness resulting from unevenness in thickness of the transparent hard coat layer 16 can be thereby reduced. Moreover, adhesion failure between the transparent base material layer 12 and the transparent hard coat layer 16 can also be suppressed. Furthermore, by preventing interference unevenness, degradation of transmission sharpness due to reflection patterns can be prevented. The wet tension of 40 mN/m or higher is not limited to that obtained as an original characteristic of the resin. The wet tension of 40 mN/m or higher may be obtained by increasing wet tension of the surface of the undercoat layer 14 by subjecting it to a corona discharge treatment or the like.

### <<Transparent Hard Coat Layer>>

The transparent hard coat layer 16 is provided in order to increase surface hardness of the optical film 1, and thereby prevent generation of scratches on the surface. Therefore, surface hardness of the transparent hard coat layer 16 of this embodiments is preferably adjusted to be H or higher, more preferably 2H or higher, still more preferably 3H or higher. If the surface hardness is adjusted to be higher than the predetermined value, generation of scratches on the surface of the optical film 1 can be effectively prevented. Value of the surface hardness is represented by pencil scratch value (pencil hardness) determined by the method of JIS-K5400 (1990).

The transparent hard coat layer 16 is constituted with a resin such as a thermoplastic resin, a thermosetting resin or an ionizing radiation curable resin. It is especially preferable to constitute it with an ionizing radiation curable resin, since such a hard coat layer can exhibit hard coat properties represented by surface hardness etc.

Examples of the thermoplastic resin and the thermosetting resin include the same resins as those mentioned as resins for constituting the undercoat layer 14.

As the ionizing radiation curable resin, photopolymerizable prepolymers which can be cured by crosslinking caused by irradiation of ionizing radiation (ultraviolet ray or electron beam) can be used. In this embodiments, the photopolymerizable prepolymers described later may be used independently or as a combination of two or more kinds of them.

The photopolymerizable prepolymers include those of cationic polymerization type and those of radical polymerization type.

Examples of the cationic polymerization type photopolymerizable prepolymers include epoxy resins, vinyl ether resins, and so forth. Examples of the epoxy resins include, for example, bisphenol type epoxy resins, novolak type epoxy resins, alicyclic epoxy resins, aliphatic epoxy resins, and so forth.

As the radical polymerization type photopolymerizable prepolymers, acrylic type prepolymers (hard prepolymers) which have two or more acryloyl groups in the molecule and form a three-dimensional reticular structure by curing via crosslinking are particularly preferably used from the viewpoint of hard coat property.

Examples of the acrylic type prepolymers include urethane acrylates, polyester acrylates, epoxy acrylates, melamine acrylates, polyfluoroalkyl acrylates, silicone acrylates, and so forth.

The urethane acrylate type prepolymers can be obtained by, for example, esterifying a polyurethane oligomer, which is obtainable by a reaction of a polyether polyol or a polyester polyol and a polyisocyanate, by a reaction with a (meth)acrylic acid. The polyester acrylate type prepolymers can be obtained by, for example, esterifying hydroxyl group of a polyester oligomer having hydroxyl groups at both ends, which is obtainable by condensation of a polybasic carboxylic acid and a polyhydric alcohol, with (meth)acrylic acid, or by esterifying hydroxyl group at an end of an oligomer, which is obtainable by adding alkylene oxide to a polybasic carboxylic acid, with (meth)acrylic acid. The epoxy acrylate type prepolymers can be obtained by, for example, esterifying an oxirane ring of a bisphenol type epoxy resin or a novolak type epoxy resin having a relatively low molecular weight by a reaction with (meth)acrylic acid. Although acrylic type prepolymers can be used independently, it is preferable to add a photopolymerizable monomer in order to impart various performances, such as improvement in crosslinking curing property and adjustment of shrinkage after curing.

Examples of the photopolymerizable monomer include monofunctional acrylic monomers (for example, 2-ethylhexyl acrylate, 2-hydroxyethyl acrylate, 2-hydroxypropyl acrylate, butoxyethyl acrylate etc.), bifunctional acrylic monomers (for example, 1,6-hexanediol diacrylate, neopentylglycol diacrylate, diethylene glycol diacrylate, polyethylene glycol diacrylate, neopentylglycol hydroxypivalate diacrylate etc.), and trifunctional acrylic monomers and those of further higher functionality (for example, dipentaerythritol hexaacrylate, trimethylpropane triacrylate, pentaerythritol triacrylate etc.). The “acrylate” not only literally includes acrylates, but also includes methacrylates. These photopolymerizable monomers may be used independently, or as a combination of two or more kinds of them.

As for formation of the transparent hard coat layer 16, when it is used after formation thereof by curing with ultraviolet irradiation, it is preferable to add additives including photopolymerization initiators, photopolymerization enhancers and ultraviolet sensitizers, in addition to the aforementioned photopolymerizable prepolymers and photopolymerizable monomers.

Examples of the photopolymerization initiators for the radical polymerization type photopolymerizable prepolymers and photopolymerizable monomers include, for example, acetophenone, benzophenone, Michler's ketone, benzoin, benzyl methyl ketal, benzoyl benzoate, α-acyl oxime ester, thioxansones, and so forth. Examples of the photopolymerization initiators for the cationic polymerization type photopolymerizable prepolymers include, for example, compounds formed from an onium such as aromatic sulfonium ions, aromatic oxosulfonium ions and aromatic iodonium ions, and an anion such as tetrafluoroborate, hexafluorophosphate, hexafluoroantimonate and hexafluoroarsenate. These may be used independently, or as a combination of two or more kinds of them. Examples of the photopolymerization enhancers include p-dimethylaminobenzoic acid isoamyl ester, p-dimethylaminobenzoic acid ethyl ester, and so forth. Examples of the ultraviolet sensitizers include n-butylamine, triethylamine, tri-n-butylphosphine, and so forth.

Amounts of these additives are usually selected to be within the range of 0.2 to 10 parts by weight based on 100 parts by weight of the total amount of the photopolymerizable prepolymer and the photopolymerizable monomer mentioned above.

Further, instead of the aforementioned photopolymerizable prepolymers, photopolymerizable monomers, and so forth, an ionizing radiation curable organic-inorganic hybrid resin can also be used as the ionizing radiation curable resin. The ionizing radiation curable organic-inorganic hybrid resin means a material showing a closely mixed state of organic substances and inorganic substances, and a dispersion state of a molecular level or a dispersion state close to that, unlike the composite materials having been used from old days, of which typical example is fiber-glass reinforced plastics (FRP), and it can form coated film by a reaction of an inorganic component and an organic component induced by irradiation of ionizing radiation.

Examples the inorganic component of the ionizing radiation curable organic-inorganic hybrid resin which can be used in the present embodiments include metal oxides such as silica and titania, and an ionizing radiation curable organic-inorganic hybrid resin using silica is especially preferred. Examples of such silica include reactive silica in which photopolymerizable photosensitive groups are introduced onto the surface thereof.

In the ionizing radiation curable organic-inorganic hybrid resin, content of the inorganic component is preferably 10 to 50% by weight, more preferably 20 to 40% by weight.

Examples of the organic component include compounds having a polymerizable unsaturated group that can be polymerized with the reactive silica, such as multivalent unsaturated organic compounds having two or more polymerizable unsaturated groups in the molecule, and monovalent unsaturated organic compounds having one polymerizable unsaturated group in the molecule.

The transparent hard coat layer 16 of the present embodiments may optionally contain additive components as required to such an extent that the effect of the present invention should not be degraded. Examples of the additive components include, for example, surface regulators, lubricants, colorants, pigments, dyes, optical whitening agents, flame retardants, antibacterial agents, antifungal agents, ultraviolet absorbers, light stabilizers, heat stabilizers, antioxidants, plasticizers, leveling agents, flow regulators, antifoams, dispersing agents, storage stabilizers, crosslinking agents, silane coupling agents, matting agents, and so forth. In particular, in order to impart anti-blocking property, a matting agent may be added in an extremely small amount (for example, about 0.1 to 5.0 parts by weight with respect to 100 parts by weight of the resin component) in such a range that the transmission sharpness should not be degraded.

Type of the matting agent that can be added is not particularly limited, and examples include inorganic particles, such as those of calcium carbonate, magnesium carbonate, barium sulfate, aluminum hydroxide, silica, kaoline, clay and talc, and resin particles such acrylic resin particles, polystyrene resin particles, polyurethane resin particles, polyethylene resin particles, benzoguanamine resin particles, and epoxy resin particles. As the matting agent, it is preferable to use spherical microparticles from the viewpoints of good handling property and ease of surface profile control, and it is preferable to use resin particles from the viewpoint of not degrading transparency.

When the hybrid resin is used as the resin component, particles of the matting agent tend to gather at the surface in the transparent hard coat layer 16, and this phenomenon is especially markedly caused when silica microparticles are used. Such a phenomenon is preferred in the present embodiments. Therefore, it is also preferable to use silica microparticles.

Although size (mean particle diameter) of the matting agent is not particularly limited, it is preferably 0.2 to 20 μm, more preferably 1.0 to 15 μm, still more preferably 2.0 to 10 μm.

However, for example, the optical film preferably shows a haze value of 5% or smaller, more preferably 3% or smaller, as measured by the method of JIS-K7136 (2000).

As the resins constituting the layers of the undercoat layer 14 and the transparent hard coat layer 16 mentioned above, it is preferable to choose those of which main component resins show solubility coefficients close to each other in order to improve adhesion between the layers. Those showing difference of solubility coefficients of 1 or smaller are particularly preferred.

For example, when an ionizing radiation curable resin is used for the transparent hard coat layer 16, resins are chosen so that difference of the solubility coefficient of the main oligomer component of the prepolymers constituting the ionizing radiation curable resin and the solubility coefficient of the monomer component constituting the main resin of the undercoat layer 14 should be 1 or smaller. Specifically, when the oligomer component of the ionizing radiation curable resin forming the transparent hard coat layer 16 is urethane acrylate, solubility coefficient thereof is 10, and therefore the undercoat layer 14 can be formed from a saturated polyester resin showing a solubility coefficient different from the solubility coefficient of 10 by 1 or smaller. The solubility coefficient is that according to the atomic group contribution method advocated by von Kreevelen, and specifically, it can be calculated according to the method described in Non-patent document 1 mentioned below.

Non-patent document 1: Polymer Handbook, Fourth Edition, John Wiley & Sons, Inc., 1999 (pages VII/675 to VII/686)

The transparent hard coat layer 16 preferably has a thickness of about 0.1 to 30 μm, more preferably 0.5 to 15 μm, still more preferably 2 to 10 μm. With a thickness of the transparent hard coat layer 16 not smaller than 0.1 μm, the transparent hard coat layer 16 can have a sufficient surface hardness (hard coat property). On the other hand, even if the thickness of the transparent hard coat layer 16 is made larger than 30 μm, surface hardness of the transparent hard coat layer 16 is not further improved. Moreover, as the thickness of the transparent hard coat layer 16 becomes larger, it tends to cause curling due to shrinkage of the transparent hard coat layer 16 upon curing, curing failure may be caused due to insufficient ultraviolet irradiation, and adhesion to the undercoat layer 14 may be degraded. Therefore, a thickness of the transparent hard coat layer 16 of 30 μm or smaller is effective from the viewpoints of economy, anti-curling property, elimination of curing failure, and adhesion to the undercoat layer 14.

### <<Anti-Reflection Layer>>

The anti-reflection layer 18 is formed in order to decrease reflection at the surface of the transparent hard coat layer 16 and thereby improve total light transmission of the whole optical film 1. In order to prevent reflection at the surface, it is also conceivable to design the transparent hard coat layer 16 to have a small refractive index. However, if the transparent hard coat layer 16 is designed to have a small refractive index, hard coat property of the transparent hard coat layer 16 may be degraded. Therefore, in this embodiments, in order to prevent reflection at the surface without degrading the hard coat property of the transparent hard coat layer 16, the anti-reflection layer 18 having a refractive index smaller than the refractive index of the transparent hard coat layer 16 is formed on the surface of the transparent hard coat layer 16 with a small thickness. That is, the anti-reflection layer 18 of this embodiments is constituted with a material having a refractive index smaller than that of the transparent hard coat layer 16. Type of such a material is not particularly limited, and examples include, for example, silicon resins, fluorocarbon resins, metal oxide sols, and mixture of these with metal oxide microparticles, preferably porous or hollow metal oxide microparticles. Further, mixtures of the resins listed in the explanation of the transparent hard coat layer 16 and the aforementioned metal oxide microparticles can also be used.

Examples of the metal oxide sol include silica sol, alumina sol, and so forth. Among these metal oxide sols, silica sol is especially preferably used in view of refractive index, flowability, and cost. The metal oxide sol refers to a material for which the Tyndall phenomenon cannot be observed due to the presence of the metal oxide, and thus means a so-called uniform solution. For example, if the Tyndall phenomenon is observed for a certain material, it is not included in the scope of the metal oxide sol in this embodiments, even if the material is one generally called colloidal silica sol.

Such metal oxide sol can be produced by hydrolyzing a metal alkoxide such as tetraethoxysilane, methyltrimethoxysilane, zirconia propoxide, aluminum isopropoxide, titanium butoxide and titanium isopropoxide. Examples of solvent of the metal oxide sol include methanol, ethanol, isopropanol, butanol, acetone, 1,4-dioxane, and so forth.

Metal oxide microparticles are obtained by making the metal oxide mentioned above into microparticles, and examples include silica microparticles, alumina microparticles, and so forth. Among these, silica microparticles are preferably used in view of refractive index, flowability, and cost. Although shape of the metal oxide microparticles is not particularly limited, porous or hollow metal oxide microparticles having a low refractive index are preferably used.

As such metal oxide microparticles, there are used those having a certain particle diameter for which the Tyndall phenomenon is observed when they are made into a dispersion. Although mean particle diameter of the metal oxide microparticles is not particularly limited so long as the aforementioned condition is satisfied, it is preferably in the range of 40 to 100 nm. If metal oxide microparticles having a mean particle diameter of 40 nm or larger are used, no metal oxide particles comes to the surface portion of the anti-reflection layer 18, and thus degradation of surface hardness can be prevented. If metal oxide microparticles having a mean particle diameter of 100 nm or smaller are used, the metal oxide microparticles do not protrude form the anti-reflection layer 18, and thus degradation of surface hardness can be prevented. Further, in order to obtain favorable transparency, mean particle diameter of the metal oxide microparticles is more preferably in the range of 40 to 70 nm.

Although mixing ratio of the metal oxide sol and the metal oxide microparticles is not particularly limited, with respect to 100 parts by weight of the metal oxide component in the metal oxide sol, the metal oxide microparticles are preferably mixed in an amount of 5 parts by weight or more, more preferably 20 parts by weight or more, and preferably 200 parts by weight or less, more preferably 100 parts by weight or less.

Thickness of the anti-reflection layer 18 preferably satisfies the following equation according to the theory for preventing reflection of light.

d=(a+1)λ/4n3 [Equation 1]

In the equation, d represents thickness of the anti-reflection layer 18 (unit is “nm”), a represents 0 or a positive even number, λ represents main wavelength of light of which reflection is to be prevented, and n3 represents refractive index of the anti-reflection layer 18. Specifically, the thickness is, for example, preferably about 2 μm or smaller, more preferably 1 μm or smaller, still more preferably 0.8 μm or smaller, particularly preferably 0.5 μm or smaller, most preferably 0.3 μm or smaller.

If the thickness of the anti-reflection layer 18 becomes lager, interference unevenness resulting from unevenness of thickness becomes difficult to occur, but it also becomes difficult for the transparent hard coat layer 16 provided on the lower surface also to exhibit hard coat property. In this embodiments, in order to prevent degradation of the hard coat property of the transparent hard coat layer 16, and degradation of anti-reflection effect due to interference of light, the anti-reflection layer 18 is formed with a small thickness on the surface of the transparent hard coat layer 16. If the anti-reflection layer 18 is formed with a small thickness, unevenness of thickness easily occurs in the anti-reflection layer 18, and interference unevenness also easily occurs originating in that unevenness in thickness of the anti-reflection layer 18. In this embodiments, since the layers of the optical film 1 are designed as described later, generation of interference unevenness resulting from unevenness in thickness of the anti-reflection layer 18 can be effectively prevented, even if the anti-reflection layer 18 is formed with a small thickness.

As for the method for forming the undercoat layer 14, the transparent hard coat layer 16, and the anti-reflection layer 18 mentioned above, each of the layers can be formed by determining composition of constituent components of the layer and other components as required, dissolving or dispersing them in an appropriate solvent to prepare a coating solution or dispersion, applying the coating solution or dispersion on the transparent base material layer 12 by a known method such as roll coatings bar coating, spray coating, air knife coating, die coating, blade coating, spin coating, photogravure coating, flow coating, and screen printing, drying the coated solution or dispersion, and optionally curing the dried layer by an appropriate curing method.

In this embodiments, the optical film is characterized in that the layers are designed so that the refractive indexes of at least the four layers, i.e., the transparent base material layer 12, the undercoat layer 14, the transparent hard coat layer 16, and the anti-reflection layer 18, which are represented by n0, n1, n2 and n3, respectively, should satisfy predetermined relationships. The inventors of the present invention found that if the refractive indexes n0 to n3 of the layers 12, 14, 16 and 18 constituting the optical film 1 satisfied specific relationships, interference unevenness resulting from unevenness of thickness could be made inconspicuous.

Specifically, in this embodiments, the layers are designed so that the relationships of n3<n2≦n1≦n0 and (n0−n3)≦0.5, preferably (n0−n3)≦0.3, should be satisfied. If the undercoat layer 14 is disposed between the transparent base material layer 12 and the transparent hard coat layer 16, and the refractive indexes n0, n1, and n2 of the transparent base material layer 12, the undercoat layer 14, and the transparent hard coat layer 16 satisfy the aforementioned relationships, differences of refractive indexes of these three layers at the interfaces become small. Further, in this embodiments, the anti-reflection layer 18 having a refractive index n3 smaller than the refractive index n2 of the transparent hard coat layer 16 is laminated on the transparent hard coat layer 16, with a small thickness. Generation of interference unevenness resulting from the unevenness in thickness of the transparent hard coat layer 16 is thereby suppressed, while transmission sharpness of the optical film is maintained to be at a high level. As a result, an optical film which can make interference unevenness inconspicuous and shows high transmission sharpness can be obtained. If the difference of the refractive indexes of the transparent base material layer 12 and the anti-reflection layer 18 becomes larger than 0.5, changes of refractive index occurring at interfaces of the layers become larger, and interference unevenness cannot be suppressed, even if the relationship of n3<n2≦n1≦n0 is satisfied.

In order to suppress interference unevenness, it is generally conceivable to form the transparent hard coat layer 16 with a fluorocarbon resin or the like and thereby make the difference of refractive indexes of the transparent base material layer 12 and the transparent hard coat layer 16 small. However, in such a case, the transparent hard coat layer 16 easily becomes brittle, adhesion thereof to the transparent base material layer 12 also reduces, and thus such means is not preferred. In this embodiments, by disposing the undercoat layer 14 and appropriately determining the differences of refractive indexes of the three layers, interference unevenness is suppressed without causing such problems. Moreover, in this embodiments, by laminating the anti-reflection layer 18 having a refractive index n3 lower than the refractive index n2 of the transparent hard coat layer 16 on the transparent hard coat layer 16 with a small film thickness, transmission sharpness of the optical film can be maintained to be at a high level, with preventing reflection at the surface.

When the transparent hard coat layer 16 is constituted with an ionizing radiation curable resin, the refractive index n2 of the transparent hard coat layer 16 is about 1.40 to 1.50. Therefore, in order to make the difference of the refractive index relative to that of the transparent base material layer 12 small, and contribute to improvement in anti-reflection property, inorganic microparticles having a refractive index higher than the refractive index of the ionizing radiation curable resin may be added to the transparent hard coat layer 16 to increase the refractive index of the transparent hard coat layer 16. As such inorganic microparticles, specifically, those having a refractive index of 1.9 or higher are preferred, and examples include, for example, those of titanium oxide, zirconium oxide, antimony oxide, tin oxide, tantalum oxide, zinc oxide, cerium oxide, lead oxide, indium oxide, gold, silver, and so forth. Among these, those of titanium oxide and zirconium oxide are preferably used in view of transparency and availability. Moreover, those of zinc oxide, titanium oxide, cerium oxide, and lead oxide are preferably used, since they can impart ultraviolet ray-shielding property. Further, those of tin oxide doped with antimony, indium oxide doped with tin, and so forth are preferably used, since they can impart antistatic property.

Such inorganic microparticles preferably have a mean particle diameter of 0.1 μm or smaller. By using inorganic microparticles having a mean particle diameter of 0.1 μm or smaller, irregular reflection of light by the transparent hard coat layer 16 can be prevented, and degradation of transparency can be thereby prevented.

Although content of the inorganic microparticles in the transparent hard coat layer 16 is not particularly limited, and cannot be generally defined since it may change depending on type of the inorganic microparticles, it is preferably such a content that a volume ratio of a resin as a binder component and the inorganic microparticles should be about 1:0.5 to 1:2. By adding the inorganic microparticles to the transparent hard coat layer 16 as described above, it can be made easy to adjust the refractive index n2 of the transparent hard coat layer 16 to be within the range described below.

In this embodiments, the optical film is preferably designed so that differences of refractive indexes of adjacent layers should satisfy the following relationships. That is, the difference of n0 and n1 should be 0.2 or smaller, preferably 0.1 or smaller. The difference of n1 and n2 should be 0.15 or smaller, preferably 0.1 or smaller. The difference of n2 and n3 should be 0.08 or larger, preferably 0.1 or larger. To make the differences of the refractive indexes of adjacent layers small as described above is still more advantageous for suppressing interference unevenness. In addition, as the difference of n2 and n3 becomes larger, reflection at the surface tends to be reduced.

In particular, in view of further advantageously preventing interference unevenness, the refractive index n0 of the transparent base material layer 12 is preferably 1.45 to 1.75, more preferably 1.50 to 1.75, the refractive index n1 of the undercoat layer 14 is preferably 1.40 to 1.70, more preferably 1.45 to 1.70, the refractive index n2 of the transparent hard coat layer 16 is preferably 1.35 to 1.70, more preferably 1.45 to 1.70, and the refractive index n3 of the anti-reflection layer 18 is preferably 1.20 to 1.47, more preferably 1.20 to 1.45.

Although a case where the transparent hard coat layer 16 is formed on only one side of the transparent base material layer 12 is exemplified in this embodiments, the transparent hard coat layer 16 may be formed on both sides of the transparent base material layer 12. In this case, the undercoat layer 14, the transparent hard coat layer 16, and the anti-reflection layer 18 may be successively laminated on one surface of the transparent base material layer 12, and a transparent hard coat layer (not shown in the drawing) other than the transparent hard coat layer 16 may be provided on the other surface of the transparent base material layer 12. Alternatively, the undercoat layer 14 and the transparent hard coat layer 16 may be provided on each surface of the transparent base material layer 12 serving as the center layer, so that the aforementioned conditions of refractive index (n3<n2≦n1≦n0 and (n0−n3)≦0.5) should be satisfied on at least one surface, preferably on both of the surfaces.

Moreover, the anti-reflection layer 18 may also be provided on both sides of the transparent base material layer 12. In this case, the undercoat layer 14, the transparent hard coat layer 16, and the anti-reflection layer 18 may be successively laminated on one surface of the transparent base material layer 12, and an anti-reflection layer (not shown in the drawing) other than the anti-reflection layer 18 may be provided on the other side of the transparent base material layer 12.

It is also possible that, while the undercoat layer 14, the transparent hard coat layer 16, and the anti-reflection layer 18 are successively laminated on one surface of the transparent base material layer 12, an adhesive layer (not shown in the drawing) is provided on the other side of the transparent base material layer 12. Examples of the material of the adhesive layer include, for example, known adhesives including elastomer adhesives of natural rubber type, reclaimed rubber type, polychloroprene rubber type, nitrile rubber type, styrene-butadiene type and so forth, synthetic resin adhesives of acrylic type, polyester type, epoxy type, urethane type, cyanoacrylate type and so forth, as well as emulsion type adhesives and so forth. The adhesive layer usually has a thickness of 15 μm or larger so that the layer should exhibit adhesion. Therefore, it hardly affects the interference unevenness.

Moreover, it is also possible to impart ultraviolet absorption property to the layers 12, 14, 16 and 18 and the adhesive layer. In particular, with a light transmission of about 0.1 to 70% for lights in the range of 350 to 380 nm, weather resistance can be imparted with maintaining the hard coat properties. When an ionizing radiation curable resin is used for the transparent hard coat layer 16, ultraviolet ray absorbing property can be imparted without affecting curing of the transparent hard coat layer 16 by adjusting the ultraviolet region in which the ionizing radiation curable resin is cured and the ultraviolet region of which lights are absorbed. For example, it is preferable to use a photopolymerization initiator showing a peak of absorption wavelength region at a position different from the peak of the absorption wavelength region of the ultraviolet absorber by 20 nm or more. By such adjustment as mentioned above, the transparent hard coat layer 16 can fully be cured, and superior hard coat properties can be imparted.

Liquid crystal display devices as image display devices are used for input devices of portable electronic organizers, portable information terminals, and so forth. Input devices of this type are used in many cases under illumination by a three-band fluorescent lamp showing a strong luminescence intensity for a specific wavelength at which objects are clearly seen. Further, when liquid crystal display devices are used for input devices of this type, a structure that a transparent touch panel is placed on a liquid crystal display device is employed. For touch panels of this type, an optical film comprising a transparent base material film and a transparent hard coat film formed on the surface of the transparent base material film is used as a surface substrate.

In this embodiments, the refractive indexes of n0 to n3 of the transparent base material layer 12, the undercoat layer 14, the transparent hard coat layer 16, and the anti-reflection layer 18 are designed so that they should satisfy the specific relationships. Interference unevenness originating in unevenness of thickness, which is difficult to be completely eliminated according to currently available precision of film forming, can be thereby made inconspicuous under an environment using a three-band fluorescent light as illuminations without reducing surface hardness and transmission sharpness.

Since interference unevenness is not conspicuous in the optical film 1 of this embodiments, it can be used for antistatic films, infrared-shielding film, anti-reflection films, scattering-prevention films, touch panels, and so forth.

### <<Laminate>>

The laminate 3 shown in FIG. 2 comprises a transparent substrate 32 and a transparent conductive film 34 laminated on at least one surface of the transparent substrate 32. In this embodiments, the transparent substrate 32 is constituted with the optical film 1 shown in FIG. 1.

For convenience of explanation, the side of the optical film 1 opposite to the side on which the anti-reflection layer 18 is provided is referred to as “back side”, and the side of the optical film 1 on which the anti-reflection layer 18 is provided is referred to as “front side”. Although a case where the transparent conductive film 34 is formed on the back side of the optical film 1, which constitutes the transparent substrate 32, is exemplified in this embodiments, it can also be provided on the front side.

The transparent conductive film 34 may be constituted with, for example, a generally and widely known transparent conductive material, organic conductive material, or the like.

Examples of the transparent conductive material include, for example, transparent conductive substances of indium oxide, tin oxide, indium tin oxide, gold, silver, palladium, and so forth.

Examples of the organic conductive material include, for example, conductive polymers such as polyparaphenylene, polyacethylene, polyaniline, polythiophene, poly(paraphenylene vinylene), polypyrrole, polyfuran, polyselenophene and polypyridine. In particular, a transparent conductive material using indium oxide, tin oxide or indium tin oxide, which shows superior transparency and conductivity, and can be obtained at a relatively low cost, as the main component can be preferably used.

The transparent conductive film 34 can be formed as a thin film using the conductive materials mentioned above by a dry process (for example, vacuum deposition, sputtering, ion-plating, etc.) or a wet process (for example, solution coating etc.).

Although thickness of the transparent conductive film 34 changes depending on the material on which it is applied, and therefore cannot be generally defined, it is desirably a thickness providing a surface resistance of 1000Ω or lower, preferably 500Ω or lower. For example, it is preferably 10 nm or larger, more preferably 20 nm or larger. From the economical viewpoint, the thickness is 80 nm or smaller, preferably 70 nm or smaller. In a thin film having such a thickness, interference fringes of visible lights due to unevenness in thickness of the transparent conductive film 104 are not easily generated. Total light transmission is usually preferably 80% or higher, more preferably 85% or higher, particularly preferably 88% or higher.

In the laminate 3 of this embodiments, interference unevenness is not conspicuous. Therefore, it can be used for antistatic films, infrared shielding film, anti-reflection films, electrode substrates of touch panels, and so forth. In the following explanation, use of the laminate 3 of this embodiments in a touch panel is exemplified.

### <<Touch Panel>>

The touch panel 5 shown in FIG. 3 is a touch panel of the resistance film type used on front surface of a display device 9 such as liquid crystal display device provided in various electronic equipments (for example, cellular phones, car navigation systems, etc.). Characters, symbols, patterns, etc. displayed on the display device 9 on the back surface can be recognized and selected through the touch panel 5, and pushed with a finger, a pen for exclusive use or the like to switch functions of the equipments.

The touch panel 5 of this embodiments has an upper electrode substrate (first electrode substrate) 52 and a lower electrode substrate (second electrode substrate) 54. The upper electrode substrate 52 has an upper transparent substrate (first transparent substrate) 522. An upper transparent conductive film (first transparent conductive film) 524 is formed on the lower surface of the upper transparent substrate 522. The lower electrode substrate (second electrode substrate) 54 has a lower transparent substrate (second transparent substrate) 542. A lower transparent conductive film (second transparent conductive film) 544 is formed on the upper surface of the lower transparent substrate 542.

Although either one of the upper electrode substrate 52 and the lower electrode substrate 54 of the touch panel 5 may be a movable electrode, a touch panel in which the upper electrode substrate 52 is a movable electrode, and the lower electrode substrate 54 is a fixed (unmovable) electrode is exemplified in this embodiments.

In this embodiments, peripheral portions of the lower surface of the upper electrode substrate 52 and the upper surface of the lower electrode substrate 54 are adhered via a spacer 56 of a frame-like shape. Further, the upper transparent conductive film 524 of the upper electrode substrate 52 and the lower transparent conductive film 544 of the lower electrode substrate 54 are disposed so that they should face each other with a predetermined gap. Multiple dot-like spacers 58 are disposed with predetermined intervals on the upper surface of the lower transparent conductive film 544 as required. The spacers 58 may be disposed as required, and a configuration not using the spacer 58 is also possible.

At the both ends of the upper and lower transparent conductive films 524 and 544, a pair of electrodes (not shown in the drawing) are formed, respectively. In this embodiments, a pair of upper electrodes (not shown in the drawing) formed on the upper transparent conductive film 524 and a pair of lower electrodes (not shown in the drawing) formed on the lower transparent conductive film 544 are disposed along directions perpendicular to each other.

In this embodiments, a separator (not shown in the drawing) may be adhered to the lower surface of the lower electrode substrate 54 via an adhesive layer 7.

In order to install the touch panel 5 of this embodiments, for example, on the front surface of the display device 9 such as color liquid crystal display device, the separator (not shown in the drawing) of the touch panel 5 of this embodiments is removed first to expose the adhesive layer 7, and the exposed adhesive layer 7 is brought into contact with the front surface of the display device 9. A color liquid crystal display device with a touch panel can be thereby formed.

In such a liquid crystal display device with a touch panel, when the upper surface of the upper electrode substrate 52 is pushed down by a user with a finger, pen or the like with recognizing images displayed on the display device 9 disposed on the back surface of the touch panel 5, the upper electrode substrate 52 is deflected, and the upper transparent conductive film 524 of the pushed part is brought into contact with the lower transparent conductive film 544. By electrically detecting this contact via the pair of upper and lower electrodes, the pushed position is detected.

In this embodiments, the upper electrode substrate 52 as a movable electrode is constituted with the laminate 3 shown in FIG. 2. The transparent conductive film 34 of the laminate 3 corresponds to the upper transparent conductive film 524. That is, it has a configuration that the upper transparent substrate 522 of the upper electrode substrate 52 is constituted with the optical film 1 shown in FIG. 1, and the upper transparent conductive film 524 is laminated on the back side of the optical film 1.

In this embodiments, the lower transparent substrate 542 of the lower electrode substrate 54 as a fixed electrode is constituted with, for example, glass or the like.

Since the touch panel 5 of this embodiments uses the laminate 3 shown in FIG. 2 as a movable electrode, it can suppress interference unevenness. Since the optical film 1 shown in FIG. 1 used in the laminate 3 shows high hard coat property and high transmission sharpness, there can be obtained effects that the touch panel 5 is scratch resistant, and images displayed on the display device 9 such as liquid crystal display device disposed on the back side of the touch panel 5 are easily recognized.

In this embodiments, in addition to the movable electrode, the laminate 3 shown in FIG. 2 can also be used for the fixed electrode (lower electrode substrate 54). A lighter, thinner and more crack resistant touch panel can be thereby obtained.

### EXAMPLES

Hereafter, the present invention will be explained in more detail with reference to examples, in which the embodiments of the present invention are more specifically embodied. The term and symbol “part” and “%” are used on weight basis, unless particularly indicated.

### Experimental Example 1

First, a coating solution for undercoat layer, a coating solution for transparent hard coat layer, and a coating dispersion for anti-reflection layer were prepared.

<Coating solution for undercoat layer>

| | | |
|---|---|---|
| Polyester resin | 1 | part |
| (Elitel UE3200, Unitika, Ltd.) | | |
| Dilution solvent | 32 | parts |

<Coating solution for transparent hard coat layer>

| | | |
|---|---|---|
| Ionizing radiation curable resin | 100 | parts |
| (solid content: 35%, Hitaloyd 7975, | | |
| Hitachi Chemical Co., Ltd.) | | |
| Photopolymerization initiator | 1 | part |
| (Irgacure 184, Ciba Speciality | | |
| Chemicals Inc.) | | |
| Dipentaerythritol hexaacrylate | 12 | parts |

Hitaloyd 7975 contained in the coating solution for transparent hard coat layer contained acrylic acrylate as the main oligomer component of prepolymers.

<Coating dispersion for anti-reflection layer>

| | |
|---|---|
| Silica sol (silica component: 10%) | 200 parts |
| Porous silica microparticle dispersion | 250 parts |
| (silica component: 5%, | |
| mean particle diameter: 55 nm) | |
| Isopropanol | 350 parts |
| n-Butanol | 350 parts |

The silica sol was prepared as follows. Tetraethoxysilane as a solution in ethanol was subjected to a hydrolysis reaction using hydrochloric acid as a catalyst to obtain silica sol containing 10% of silica component. The Tyndall phenomenon could not be observed in the obtained silica sol.

Then, the prepared coating solution for undercoat layer was applied to one surface of a transparent polymer film (polyethylene terephthalate, refractive index: 1.65) having a thickness of 100 μm as the transparent base material layer 12 by bar coating and cured by heating to obtain the undercoat layer 14 (refractive index: 1.60) made of polyester resin and having a thickness of about 0.2 μm.

Then, the prepared coating solution for transparent hard coat layer was applied on the undercoat layer 14 by bar coating and dried to form a coated film. The formed coated film was then cured by ultraviolet irradiation performed with a high pressure mercury vapor lamp to form the transparent hard coat layer 16 (refractive index: 1.53) made of ionizing radiation curable resin and having a thickness of about 10 μm. At this point, adhesion of the transparent hard coat layer 16 (henceforth also referred to as “Adhesion 1”) was evaluated as follows. “Adhesion 1” was evaluated according to the cross cutting method of JIS-K5600-5-6. First, the prepared laminate was cut on the side of the transparent hard coat layer 16 so that 100 grids should be formed with intervals of 1 mm, a cellophane adhesive tape defined in JIS-Z1522 was adhered to the cut surface and peeled, and then the state of the coated film was observed by visual inspection. The evaluation results are indicated with “◯” when no delamination occurred at all, with “Δ” when slight delamination occurred, or with “X” when complete delamination occurred.

Then, the prepared coating dispersion for anti-reflection layer was applied to the transparent hard coat layer 16 by bar coating, and cured by heating to form the anti-reflection layer 18 (refractive index: 1.36) having a thickness of about 0.1 μm so that it should show the minimum reflection rate around a wavelength of 550 nm, and thereby obtain a film sample.

The obtained film sample was evaluated for interference unevenness, Adhesion 2, transmission sharpness, and pencil hardness by the following methods, and values of haze and absolute mirror surface reflection were measured. The results are shown in Table 1.

(1) “Interference unevenness” was evaluated as follows. First, the film sample was placed on a black cloth so that the side on which the anti-reflection layer was provided should be the upper side. Then, illumination light was irradiated on the side of the anti-reflection layer of the film sample with a three-band lamp. Then, interference unevenness generated in the reflected light was visually observed from a position where image of the three-band lamp produced by the reflected light could be observed. The evaluation results are indicated with “⊚” when interference unevenness was completely inconspicuous, with “◯” when interference unevenness was inconspicuous, with “Δ” when interference unevenness was present, but inconspicuous, or with “X” when interference unevenness was very conspicuous.
(2) “Adhesion 2” was evaluated as follows. The film sample was cut on the side of the anti-reflection layer 18 along two of straight lines perpendicular to each other at an angle of 90°, and then the condition of the coated layer was observed by visual inspection. The evaluation results are indicated with “◯” when there was no delamination at the crossing position of cuts, or with “X” when there was delamination.
(3) “Transmission sharpness” was evaluated as follows. Image clarity of optical comb of 2.0 mm was measured through the film sample using an image clarity meter (ICM-1DP, Suga Test Instruments Co., Ltd.) according to the method of JIS-K7105. The results are indicated with “◯” when the measured value was 90% or higher, with “Δ” when the measured value was not lower than 80% but lower than 90%, or with “X” when the measured value was lower than 80%. The measurement of image clarity was performed by entering light from the side of the anti-reflection layer 18.
(4) As for pencil hardness, pencil scratch value of the film sample surface was measured by the method of JIS-K5400 (1990). The evaluation results are indicated with “⊚” when the obtained measured value was 2H or higher, with “◯” when the obtained measured value was not lower than H but lower than 2H, or “X” when the obtained measured value is lower than H.
(5) As for “haze”, haze value of the film sample was measured by using a haze meter (NDH2000, Nippon Denshoku Industries Co., Ltd.) according to the method of JIS-K7136 (2000) (unit is “%”). The measurement of the haze value was performed by entering light from the side of the anti-reflection layer 18. The evaluation results are indicated with “◯” when haze was 5% or lower, or with “X” when haze exceeded 5%.
(6) “Absolute mirror surface reflection” was evaluated as follows. First, a black adhesive tape was adhered to the surface of the film sample on the side opposite to the side on which the anti-reflection layer was provided. Then, mirror reflectance of the surface of the film sample on the side on which the anti-reflection layer was provided was measured at an incidence angle of 5° and a reflection angle of 5° using a spectrophotometer (UV3101PC, Shimadzu Corp.) (this reflectance represents the minimum reflectance at the wavelength of 550 nm, unit is %). The evaluation results are shown with “⊚” when the measurement result was 2.0% or smaller, with “◯” when the measurement result was larger than 2.0% and not larger than 3.0%, or with “X” when the measurement result exceeded 3.0%. The results are also numerically indicated.

Further, “solubility coefficients” of the main components of the undercoat layer 14 and the transparent hard coat layer 16 were calculated. Difference of them of 1 or smaller is shown as “≦1”, and the difference larger than 1 is shown as “>1”. When the undercoat layer 14 was formed on the transparent base material layer 12, “wet tension” of the formed undercoat layer 14 was measured. Wet tension was measured according to the method of JIS-K6768 (1999). As a test mixture, one showing a wet tension of 40.0 mN/m was used. Values of wet tension of 40.0 mN/m or larger are indicated as “40≦” and the values lower than 40.0 mN/m are indicated as “<40”. These results are also shown in Table 1.

### Experimental Example 2

Coating solutions and dispersion were prepared, and a film sample was obtained in the same manners as those of Experimental Example 1, except that a coating solution for transparent hard coat layer prepared with the following composition was used. Then, the same measurements and evaluations as those of Experimental Example 1 were performed. The results are shown in Table 1.

<Coating solution for transparent hard coat layer>

| | | |
|---|---|---|
| Ionizing radiation curable resin | 10 | parts |
| (Beamset 575, Arakawa Chemical | | |
| Industries, Ltd.) | | |
| Photopolymerization initiator | 0.5 | part |
| (Irgacure 184, Ciba Japan K.K.) | | |
| Dilution solvent | 10 | parts |

Beamset 575 contained in the coating solution for transparent hard coat layer contained urethane acrylate as the main oligomer component of prepolymers.

In this experimental example, the prepared coating solution for transparent hard coat layer was applied to the undercoat layer 14 by bar coating, and dried to form a coated film, and ultraviolet radiation was irradiated on the coated film with a high pressure mercury vapor lamp to cure the film and thereby form a transparent hard coat layer 16 having a thickness of about 10 μm and made of ionizing radiation curable resin (refractive index: 1.50).

### Experimental Example 3

Coating solutions and dispersion were prepared, and a film sample was obtained in the same manners as those of Experimental Example 1, except that another transparent polymer film having a thickness of 100 μm (polyethylene naphthalate, refractive index: 1.75) was used as the transparent base material layer 12. Then, the same measurements and evaluations as those of Experimental Example 1 were performed. The results are shown in Table 1.

### Experimental Example 4

A coating solution for undercoat layer was prepared with the following composition.

<Coating solution for undercoat layer>

| | |
|---|---|
| Acrylic resin (Julymer FC60, | 1 part |
| Nihon Junyaku Co., Ltd.) | |
| Dilution solvent | 7 parts |

Then, the prepared coating solution for undercoat layer was applied to one surface of a transparent polymer film having a thickness of 100 μm (polycarbonate, refractive index: 1.59) as the transparent base material layer 12 by bar coating, and cured by heating to form the undercoat layer 14 having a thickness of about 0.2 μm and made of acrylic resin (refractive index: 1.50).

Then, the coating solution for transparent hard coat layer of Experimental Example 2 was applied to the undercoat layer 14 by bar coating, and dried to form a coated film. Then, the formed coated film was cured by ultraviolet irradiation using a high pressure mercury vapor lamp to form the transparent hard coat layer 16 having a thickness of about 10 μm and made of ionizing radiation curable resin (refractive index: 1.50). At this stage, Adhesion 1 of the transparent hard coat layer 16 was evaluated in the same manner as that of Experimental Example 1.

Then, the coating dispersion for anti-reflection layer of Experimental Example 1 was applied to the transparent hard coat layer 16 by bar coating, and cured by heating to form the anti-reflection layer 18 having a thickness of about 0.1 μm (refractive index: 1.36) and thereby obtain a film sample. Then, the same measurements and evaluations as those of Experimental Example 1 were performed. The results are shown in Table 1.

### Experimental Example 5

The coating solution for undercoat layer of Experimental Example 4 was applied to one surface of the transparent polymer film of Experimental Example 1 (refractive index: 1.65) by bar coating, and cured by heating to form the undercoat layer 14 (refractive index: 1.50) similar to that of Experimental Example 4.

Then, the coating solution for transparent hard coat layer of Experimental Example 1 was applied to the undercoat layer 14 by bar coating, and dried to form a coated film. Then, the formed coated film was cured by ultraviolet irradiation using a high pressure mercury vapor lamp to form the transparent hard coat layer 16 (refractive index: 1.53) similar to that of Experimental Example 1.

Then, the coating dispersion for anti-reflection layer of Experimental Example 1 was applied to the transparent hard coat layer 16 by bar coating, and cured by heating to form the anti-reflection layer 18 (refractive index: 1.36) similar to that of Experimental Example 1 and thereby obtain a film sample. Then, the same measurements and evaluations as those of Experimental Example 1 were performed. The results are shown in Table 1.

### Experimental Example 6

A coating solution for undercoat layer was prepared with the following composition.

<Coating solution for undercoat layer>

| | |
|---|---|
| Polyvinyl acetate (Gohsenol GL05, | 10 parts |
| Nippon Synthetic Chemical | |
| Industry Co., Ltd.) | |
| Dilution solvent | 10 parts |

Then, the prepared coating solution for undercoat layer was applied to one surface of the transparent polymer film of Experimental Example 1 (refractive index: 1.65) by bar coating, and cured by heating to form the undercoat layer 14 having a thickness of about 0.2 μm and made of polyvinyl acetate (refractive index: 1.45).

Then, the coating solution for transparent hard coat layer of Experimental Example 1 was applied to the undercoat layer 14 by bar coating, and dried to form a coated film. Then, the formed coated film was cured by ultraviolet irradiation using a high pressure mercury vapor lamp to form the transparent hard coat layer 16 (refractive index: 1.53) similar to that of Experimental Example 1.

Then, the coating dispersion for anti-reflection layer of Experimental Example 1 was applied to the transparent hard coat layer 16 by bar coating, and cured by heating to form the anti-reflection layer 18 (refractive index: 1.36) similar to that of Experimental Example 1 and thereby obtain a film sample. Then, the same measurements and evaluations as those of Experimental Example 1 were performed. The results are shown in Table 1.

### Experimental Example 6-1

A coating solution for transparent hard coat layer was prepared with the following composition.

<Coating solution for transparent hard coat layer>

| | | |
|---|---|---|
| Ionizing radiation curable | 100 | parts |
| organic-inorganic hybrid resin | | |
| (solid content: 50%, | | |
| inorganic component: 38%, | | |
| DeSolite 7503, JSR Corporation) | | |
| Microparticles (silica, | 1.9 | parts |
| mean particle diameter: 3.5 μm | | |
| coefficient of variation: 60%) | | |
| Methyl ethyl ketone | 40 | parts |
| Toluene | 15 | parts |

Then, the coating solution for undercoat layer of Experimental Example 1 was applied to one surface of the transparent polymer film of Experimental Example 1 (refractive index: 1.65) by bar coating, and cured by heating to form the undercoat layer 14 (refractive index: 1.60) similar to that of Experimental Example 4.

Then, the prepared coating solution for transparent hard coat layer was applied to the undercoat layer 14 by bar coating, and dried to form a coated film. Then, the formed coated film was cured by ultraviolet irradiation using a high pressure mercury vapor lamp to form the transparent hard coat layer 16 (refractive index: 1.50).

Then, the coating dispersion for anti-reflection layer of Experimental Example 1 was applied to the transparent hard coat layer 16 by bar coating, and cured by heating to form the anti-reflection layer 18 (refractive index: 1.36) similar to that of Experimental Example 1 and thereby obtain a film sample. Then, the same measurements and evaluations as those of Experimental Example 1 were performed. The results are shown in Table 1.

### Experimental Example 6-2

The coating solution for undercoat layer of Experimental Example 6 was applied to one surface of the transparent polymer film of Experimental Example 1 (refractive index: 1.65) by bar coating, and cured by heating to form the undercoat layer 14 (refractive index: 1.45) similar to that of Experimental Example 6.

Then, the coating solution for transparent hard coat layer of Experimental Example 6-1 was applied to the undercoat layer 14 by bar coating, and dried to form a coated film. Then, the formed coated film was cured by ultraviolet irradiation using a high pressure mercury vapor lamp to form the transparent hard coat layer 16 (refractive index: 1.50).

Then, the coating dispersion for anti-reflection layer of Experimental Example 1 was applied to the transparent hard coat layer 16 by bar coating, and cured by heating to form the anti-reflection layer 18 (refractive index: 1.36) similar to that of Experimental Example 1 and thereby obtain a film sample. Then, the same measurements and evaluations as those of Experimental Example 1 were performed. The results are shown in Table 1.

### Experimental Example 7

A coating dispersion for anti-reflection layer was prepared with the following composition.

<Coating dispersion for anti-reflection layer>

| | | |
|---|---|---|
| Ionizing radiation curable resin | 50 | parts |
| (solid content: 100%, CN-120A60, | | |
| Nippon Kayaku Co., Ltd.) | | |
| Polyfunctional acrylate | 50 | parts |
| (trimethylolpropane triacrylate (TMPTA), | | |
| solid content: 100%) | | |
| Photopolymerization initiator | 3 | parts |
| (Irgacure 184, Ciba Japan K.K.) | | |
| Porous silica microparticles | 100 | parts |
| (mean particle diameter: 55 nm) | | |
| Dilution solvent | 6500 | parts |

Then, the coating solution for undercoat layer of Experimental Example 1 was applied to one surface of the transparent polymer film of Experimental Example 1 (refractive index: 1.65) by bar coating, and cured by heating to form the undercoat layer 14 (refractive index: 1.60) similar to that of Experimental Example 4.

Then, the coating solution for transparent hard coat layer of Experimental Example 1 was applied to the undercoat layer 14 by bar coating, and dried to form a coated film. Then, the formed coated film was cured by ultraviolet irradiation using a high pressure mercury vapor lamp to form the transparent hard coat layer 16 (refractive index: 1.53) similar to that of Experimental Example 1.

Then, the prepared coating dispersion for anti-reflection layer was applied to the transparent hard coat layer 16 by bar coating, and dried to form a coated film. Then, the formed coated film was cured by ultraviolet irradiation using a high pressure mercury vapor lamp to form the anti-reflection layer 18 having a thickness of about 0.1 μm (refractive index: 1.37) and thereby obtain a film sample. Then, the same measurements and evaluations as those of Experimental Example 1 were performed. The results are shown in Table 1.

### Experimental Example 8

Coating solutions were prepared, and a film sample was obtained in the same manners as those of Experimental Example 1, except that the porous silica microparticle dispersion was excluded from the coating dispersion for anti-reflection layer of Experimental Example 1. Then, the same measurements and evaluations as those of Experimental Example 1 were performed. The results are shown in Table 1.

In this experimental example, the prepared coating solution for anti-reflection layer was applied to the transparent hard coat layer 16 by bar coating, and cured by heating to form the anti-reflection layer 18 having a thickness of about 0.1 μm (refractive index: 1.44).

### Experimental Example 9

Coating solutions were prepared, and a film sample was obtained in the same manners as those of Experimental Example 1, except that a coating solution for anti-reflection layer prepared with the following composition was used. Then, the same measurements and evaluations as those of Experimental Example 1 were performed. The results are shown in Table 1.

<Coating solution for anti-reflection layer>

| | |
|---|---|
| Polyester resin (solid content 100%, | 1 part |
| Vylon 200, Toyobo Co., Ltd.) | |
| Dilution solvent | 19 parts |

In this experimental example, the prepared coating solution for anti-reflection layer was applied to the transparent hard coat layer 16 by bar coating, and cured by heating to form the anti-reflection layer 18 having a thickness of about 0.1 μm (refractive index: 1.55).

### Experimental Example 10

Coating solutions were prepared, and a film sample was obtained in the same manners as those of Experimental Example 1, except that a coating solution for anti-reflection layer prepared with the following composition was used. Then, the same measurements and evaluations as those of Experimental Example 1 were performed. The results are shown in Table 1.

<Coating solution for anti-reflection layer>

| | |
|---|---|
| Acrylic resin (solid content: 50%, | 5 parts |
| ACRYDIC A814, Dainippon Ink & | |
| Chemicals, Inc.) | |
| Dilution solvent | 45 parts |

In this experimental example, the prepared coating solution for anti-reflection layer was applied to the transparent hard coat layer 16 by bar coating, and cured by heating to form the anti-reflection layer 18 having a thickness of about 0.1 μm (refractive index: 1.50).

TABLE 1

| Experimental | Refractive index | | | | Difference of refractive index | | | | Wet tension | Solubility |
|---|---|---|---|---|---|---|---|---|---|---|
| example | n0 | n1 | n2 | n3 | n0 − n3 | n0 − n1 | n1 − n2 | n2 − n3 | (mN/m) | coefficient |
| 1 | 1.65 | 1.60 | 1.53 | 1.36 | 0.29 | 0.05 | 0.07 | 0.17 | 40≦ | ≦1 |
| 2 | 1.65 | 1.60 | 1.50 | 1.36 | 0.29 | 0.05 | 0.10 | 0.14 | 40≦ | ≦1 |
| 3 | 1.75 | 1.60 | 1.53 | 1.36 | 0.39 | 0.15 | 0.07 | 0.17 | 40≦ | ≦1 |
| 4 | 1.59 | 1.50 | 1.50 | 1.36 | 0.23 | 0.09 | 0.00 | 0.14 | 40≦ | ≦1 |
| 5 | 1.65 | 1.50 | 1.53 | 1.36 | 0.29 | 0.15 | −0.03 | 0.17 | 40≦ | ≦1 |
| 6 | 1.65 | 1.45 | 1.53 | 1.36 | 0.29 | 0.20 | −0.08 | 0.17 | 40≦ | ≦1 |
| 6-1 | 1.65 | 1.60 | 1.50 | 1.36 | 0.29 | 0.05 | 0.10 | 0.14 | 40≦ | ≦1 |
| 6-2 | 1.65 | 1.45 | 1.50 | 1.36 | 0.29 | 0.20 | −0.05 | 0.14 | 40≦ | ≦1 |
| 7 | 1.65 | 1.60 | 1.53 | 1.37 | 0.28 | 0.05 | 0.07 | 0.16 | 40≦ | ≦1 |
| 8 | 1.65 | 1.60 | 1.53 | 1.44 | 0.21 | 0.05 | 0.07 | 0.09 | 40≦ | ≦1 |
| 9 | 1.65 | 1.60 | 1.53 | 1.55 | 0.10 | 0.05 | 0.07 | −0.02 | 40≦ | ≦1 |
| 10 | 1.65 | 1.60 | 1.53 | 1.50 | 0.15 | 0.05 | 0.07 | 0.03 | 40≦ | ≦1 |

| | | | | | | | |
|---|---|---|---|---|---|---|---|
| | | | | | | | Absolute mirror |
| Experimental | interference | Adhesion | Adhesion | Transmission | Pencil | | surface reflection |
| example | unevenness | 1 | 2 | sharpness | hardness | Haze | (%) |

| | | | | | | | | |
|---|---|---|---|---|---|---|---|---|
| 1 | ⊚ | ◯ | ◯ | ◯ | ◯ | ◯ | 1.6 | ⊚ |
| 2 | ⊚ | ◯ | ◯ | ◯ | ◯ | ◯ | 1.7 | ⊚ |
| 3 | ◯ | ◯ | ◯ | ◯ | ◯ | ◯ | 1.7 | ⊚ |
| 4 | ⊚ | ◯ | ◯ | ◯ | ◯ | ◯ | 1.9 | ⊚ |
| 5 | X | ◯ | ◯ | ◯ | ◯ | ◯ | 1.7 | ⊚ |
| 6 | X | ◯ | ◯ | ◯ | ◯ | ◯ | 2 | ⊚ |
| 6-1 | ⊚ | ◯ | ◯ | ◯ | ◯ | ◯ | 1.4 | ⊚ |
| 6-2 | Δ | ◯ | ◯ | Δ | ◯ | ◯ | 1.4 | ⊚ |
| 7 | ⊚ | ◯ | ◯ | ◯ | ⊚ | ◯ | 1.6 | ⊚ |
| 8 | ⊚ | ◯ | ◯ | ◯ | ⊚ | ◯ | 2.1 | ◯ |
| 9 | Δ | ◯ | X | ◯ | X | ◯ | 4.5 | X |
| 10 | ⊚ | ◯ | X | ◯ | X | ◯ | 3.7 | X |

The followings could be confirmed from the results shown in Table 1. First, as for interference unevenness, when the refractive index n2 of the transparent hard coat layer 16 was larger than the refractive index n1 of the undercoat layer 14 (n2>n1, Experimental Examples 5, 6 and 6-2), or the refractive index n3 of the anti-reflection layer 18 is not larger than the refractive index n2 of the transparent hard coat layer 16 (n3≧n2, Experimental Example 9), and thus the relationship of n3<n2≦n1≦n0 was not satisfied, there was at least interference unevenness, and it was conspicuous. On the other hand, when the relationship of n3<n2≦n1≦n0 was satisfied (Experimental Examples 1 to 4, 6-1, 7, 8 and 10), there was not interference unevenness, and favorable results were obtained. Especially in Experimental Examples 1 to 4, 6-1, 7, 8 and 10, despite that the anti-reflection layers 18 were formed with a small thickness, generation of interference unevenness, which is easily generated due to unevenness in thickness of the anti-reflection layer 18, was sufficiently suppressed.

As for the pencil hardness, when a polyester resin or acrylic resin was used as the binder of the anti-reflection layer 18 (Experimental Examples 9 and 10), sufficient pencil hardness was not obtained. On the other hand, sufficient pencil hardness was obtained in Experimental Examples 1 to 8.

As for the transmission sharpness and haze, since a matting agent, which may serve as a factor of opacity, was not contained, favorable results were obtained in all the experimental examples. On the other hand, in Experimental Example 6-1, silica, which may serve as a factor of opacity, was contained. However, the content thereof was reduced to an extremely small amount, and therefore there could be obtained an optical film of which blocking could be prevented without affecting transmission sharpness.

From these results, it could be confirmed that, among the film samples of the experimental examples, those maintaining sufficient pencil hardness and transmission sharpness in which interference unevenness was inconspicuous were those of Experimental Examples 1 to 4, 6-1, 7 and 8, and those showing particularly superior performance among them were those of Experimental Examples 1, 2, 4, 7 and 8. That is, it could be confirmed that, in the samples of Experimental Examples 1, 2, 4, 7 and 8, interference fringes could be made inconspicuous with maintaining high pencil hardness and transmission sharpness. Moreover, among those of Experimental Examples 1, 2, 4, 7 and 8, those of Experimental Examples 1, 2, 4 and 7, in which n2−n3 was larger than 0.1, were showed particularly superior anti-reflection property.

### Experimental Example 11

First, a first laminate sample as the upper electrode substrate 52 shown in FIG. 3 was produced by forming an ITO film having a thickness of about 20 nm on the back side (surface on the side opposite to the side of the anti-reflection layer 18) of the film sample obtained in Experimental Example 1 by sputtering.

Then, a second laminate sample as the lower electrode substrate 54 shown in FIG. 3 was prepared by forming an ITO film having a thickness of about 20 nm on one surface of a tempered glass plate having a thickness of 1 mm by sputtering, and then cutting it into a 4-inch size (rectangle having a length of 87.3 mm and a width of 64.0 mm).

Then, dots were printed with an ionizing radiation curable resin (DotCure TR5903, Taiyo Ink Mfg. Co., Ltd.) as a coating solution for spacer by screen printing on the ITO film surface of the second laminate sample, and ultraviolet irradiation was performed with a high pressure mercury vapor lamp to dispose spacers 58 having a diameter of 50 μm and a height of 8 μm with intervals of 1 mm.

Then, the first laminate sample and the second laminate sample on which the spacers 58 were arranged were disposed so that the ITO films of the samples should face each other, and the edges were fixed with a double-sided adhesive tape having a thickness of 30 μm and a width of 3 mm to prepare a touch panel sample corresponding to the touch panel 5 shown in FIG. 3. In this experimental example, the edges were fixed so that the adhered portions of the samples should be out of the display region of the touch panel sample.

It could be confirmed that, in the produced touch panel sample, interference unevenness was inconspicuous, and as a result, it could be favorably operated.

1. An optical film comprising a transparent base material layer, an undercoat layer laminated on at least one of surfaces of the transparent base material layer, a transparent hard coat layer laminated on surface of the undercoat layer, and an anti-reflection layer laminated on surface of the transparent hard coat layer, wherein:
refractive index n0 of the transparent base material layer, refractive index n1 of the undercoat layer, refractive index n2 of the transparent hard coat layer, and refractive index n3 of the anti-reflection layer satisfy the relationships of n3<n2≦n1≦n0, and (n0−n3)≦0.5.

2. The optical film according to claim 1, wherein:
the relationships of (n0−n1)≦0.2, (n1−n2)≦0.15, and (n2−n3)≧0.08 are satisfied.

3. The optical film according to claim 1 or 2, wherein:
n0 is 1.45 to 1.75, n1 is 1.40 to 1.70, n2 is 1.35 to 1.70, and n3 is 1.20 to 1.47.

4. The optical film according to claim 1, wherein:
the anti-reflection layer has a thickness of 2 μm or smaller.

5. The optical film according to claim 1, wherein:
the undercoat layer shows a value of wet tension of 40 mN/m or larger as measured according to JIS-K6768 (1999).

6. The optical film according to claim 1, wherein:
the film shows a haze value of 5% or smaller as measured according to JIS-K7136 (2000).

7. A laminate comprising a transparent substrate and a transparent conductive film provided on at least one surface of the transparent substrate, wherein:
the transparent substrate is constituted with the optical film according to claim 1.

8. A touch panel comprising a first electrode substrate comprising a first transparent substrate and a first transparent conductive film formed on the first transparent substrate and a second electrode substrate comprising a second transparent substrate and a second transparent conductive film formed on the second transparent substrate, which are disposed so that the first transparent conductive film and the second transparent conductive film should face each other with a predetermined gap, wherein:
at least one of the first transparent substrate and the second transparent substrate is constituted with the optical film according to claim 1.

9. The transparent touch panel according to claim 8, wherein:
either one of the first electrode substrate and the second electrode substrate is a movable electrode substrate, the other is a fixed electrode substrate, and the movable electrode substrate comprises a transparent substrate constituted with the optical film according to claim 1.
